(19) United States
(12) Patent Application Publication
(10) Pub. No.: US 2007/0041523 A1
(43) Pub. Date: Feb. 22, 2007

(54) Method for identifying and responding to chronic callers in an interactive voice response system

(75) Inventors: Jonathan Paden, Austin, TX (US); Scott Newman, Little Elm, TX (US); Bobby Sams, Austin, TX (US); William A. Baldassari, Granite Bay, CA (US); Alex Yip, Plano, TX (US)

Correspondence Address: AKERMAN SENTERFITT, P.O. BOX 3188, WEST PALM BEACH, FL, 33402-3188, US

(73) Assignee: SBC Knowledge Ventures LP, Reno, NV (US)

(21) Appl. No.: 11/204,455

(22) Filed: Aug. 16, 2005

(51) Int. Cl. H04M 11/00; H04M 15/00; H04M 3/00; H04M 5/00

(52) U.S. Cl. 379/88.16; 379/265.01; 379/114.1

(57) ABSTRACT

An interactive voice response system (IVR) (100) has a communications interface (110), a memory (104), and a controller (102). The controller is programmed to monitor (202) a frequency of call activity for each caller, establish (208) a redirection criterion, and redirect (210) a caller to special services when the frequency of call activity of said caller satisfies the redirection criterion.

### FIELD OF THE INVENTION

The present disclosure relates generally to network management techniques, and more specifically to a method for identifying and responding to chronic callers in an interactive voice response system (IVR).

### BACKGROUND

Service providers typically utilize IVRs for managing product sales, technical support, billing and other services. The call flows of an IVR will generally dictate interactions with a caller, and whether human intervention is necessary to address the caller's needs. During interactions with a caller, a caller may be disconnected by choice or in error. This can lead to frustrated callers who chronically call the IVR in an attempt to reach a service agent. Additionally, IVRs can be interrupted by callers who act erratically with intentions to interrupt service for no obvious reason.

A need therefore arises for a method and apparatus to identify and respond to chronic callers in an IVR.

### BRIEF DESCRIPTION OF THE DRAWINGS

FIG. 1 is a block diagram of an IVR coupled to a communications network serving customer needs incorporating teachings of the present disclosure;

FIG. 2 depicts a flowchart of a method operating in the IVR incorporating teachings of the present disclosure; and

FIG. 3 is a diagrammatic representation of a machine in the form of a computer system within which a set of instructions, when executed, may cause the machine to perform any one or more of the methodologies discussed herein.

### DETAILED DESCRIPTION OF THE DRAWINGS

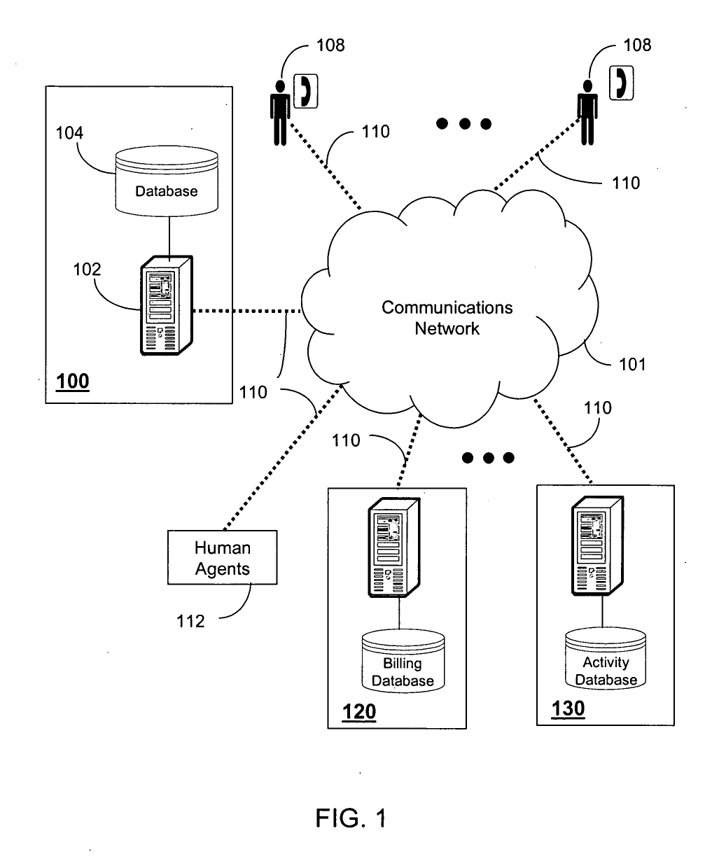

FIG. 1 is a block diagram of an interactive voice response system (IVR) 100 coupled to a communications network 101 serving customers 108 incorporating teachings of the present disclosure. The IVR 100 comprises a communications interface 110, a memory 104 and a controller 102. The communications interface 110 utilizes conventional wired or wireless communications technology for interfacing to the communications network 101. The communications interface 110 can represent a circuit switched and/or a packet switched interface. Internet or traditional voice services can be provided by network 101 to customers 108. Thus, the communications network 101 can support multiple services such as: POTS (Plain Old Telephone Service), VoIP (Voice over Internet communications, IPTV (Internet Protocol Television), broadband communications, cellular telephony, and other known or future communication services.

The controller 102 utilizes conventional computing technology such as a desktop computer, or a scalable server. The memory 104 utilizes conventional mass storage media such as a high capacity disk drive, and can be used by the controller 102 to manage a database in accordance with the present disclosure. The IVR 100 can also use conventional applications such as an IVR (Interactive Voice Response) application, and/or a CRM (Customer Relations Management) application for interacting with customers 108 and managing account information, respectively.

By way of the communications interface 110, the IVR 100 can access independently operated remote systems such as a billing system 120 and/or an product sales system 130. The IVR 100 can also perform updates on, for example, the billing system 120 as it processes customer calls in accordance with the disclosure. It will be appreciated that in the alternative the remote systems 120 and 130 can be in whole or in part an integral part of the IVR 100. Where the IVR 100 is unable to serve particular customer requests, it can direct such callers to one or more human agents 112 of the service provider as needed.

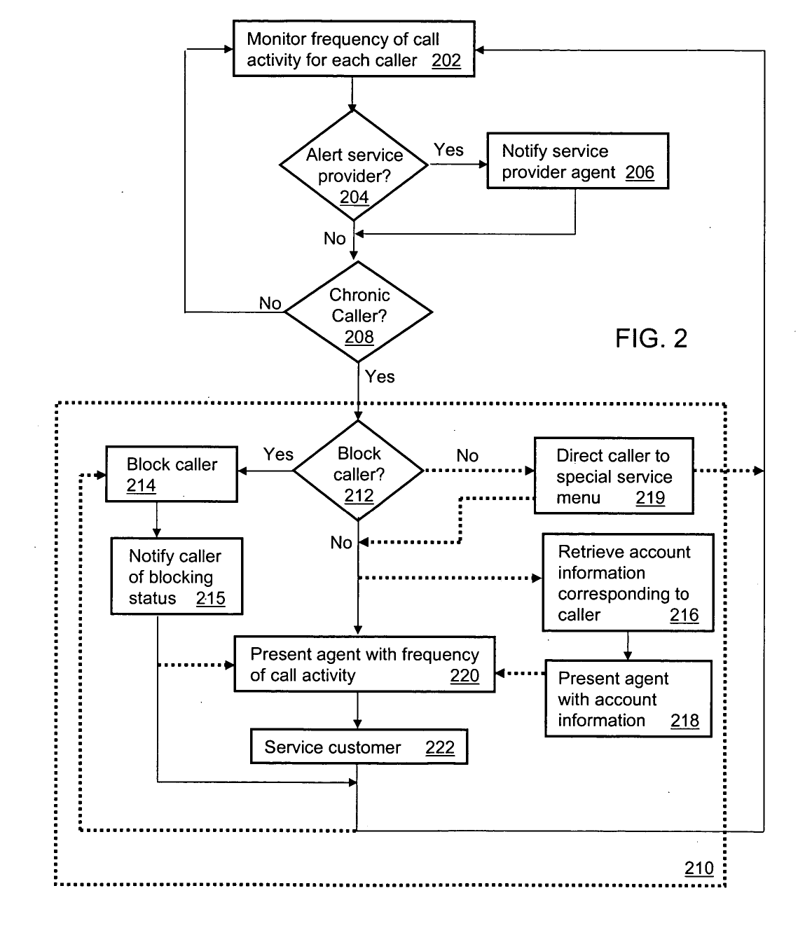

FIG. 2 depicts a flowchart of a method 200 operating in the IVR 100 incorporating teachings of the present disclosure. Method 200 begins with step 202 where the IVR 100 is programmed to monitor a frequency of call activity for each caller. The frequency of call activity for each caller can corresponds to, for example, a number of calls made by each caller, a number of voluntary call terminations by each caller, a number of involuntary call terminations by each caller, and/or a temporal reading (e.g., time measure) of each call activity of a caller.

In a supplemental embodiment of the present disclosure, the service provider can establish alert criterion for notifying a service provider when the frequency of call activity of one or more callers has been satisfied. When the alert criterion is triggered in step 204, an agent of the service provider is notified in step 206. An alert criterion can be chosen by the service provider as any useful trigger for identifying issues with callers that may warrant service provider intervention. For example, an alert criterion can be established to monitor when more than ten callers have called more than once on the same day within a one our period of each other. Such a criterion can indicate to the service provider that IVR 100 and/or service agents operating with the IVR 100 are not effectively handling caller needs and/or or the volume of calls is higher than the IVR 100 and/or agents are capable of handling effectively. There are obviously innumerous criterions that can be chosen by the service provider in accordance with the present disclosure. The notification step 206 can be accomplished by any conventional communication means such as email, an over-the-air message (e.g., SMS—Short Message System), a page or other known or future alerting means.

Whether or not the service provider is alerted, the IVR 100 can be programmed to proceed to step 208 to determine if a redirection criterion has been satisfied. In this illustration, the redirection criterion is illustrated as a threshold for identifying chronic callers. The threshold can be established using Boolean logic for detecting any number of events such as, for example, a threshold of involuntary terminations, and/or a threshold of voluntary terminations, and/or a threshold of calls within a defined period of time. If the caller is not a chronic caller (because none of the foregoing thresholds have been crossed), the IVR 100 repeats the monitoring step 202. If, on the other hand, the caller is identified as a chronic caller after triggering one or more of the aforementioned Boolean thresholds, the IVR 100 proceeds to step 210 where the caller is redirected to special services of the service provider. It should be evident to those skilled in the art that there is any number of logical choices for redirection criterions to address chronic callers. Step 210 is simply illustrative of one of many arrangements that the service provider can choose in accordance with the present disclosure.

As illustrated in step 210, special services can include, for example, a choice of blocking specific callers from further access to the IVR 100, redirecting said callers to service agents of the service provider trained to address chronic callers, or a call flow menu of the IVR 100 that address chronic calls. As noted earlier, there are numerous other redirection techniques not addressed in the present disclosure. Thus, in a first embodiment of step 210, when a chronic caller is identified in step 208, a determination can be made in step 212 whether the caller should be blocked from further access to the IVR 100. The filter criterion for blocking calls can be based on, for example, logic that identifies the aggressive nature of the caller and/or whether the caller's behavior is more conducive to harassment than an honorable attempt to request services for specific needs. The logic can search, for instance, the closeness in time between calls, whether the calls were voluntarily terminated, whether the caller was choosing a call flow in the IVR 100 erratically, and so on. The service provider can thus choose a set of criterion using any suitable logic therefor to identify callers who are or may be attempting to interrupt services of the IVR 100.

If the criterion is satisfied in step 212, the IVR 100 proceeds to step 214 where it blocks one or more callers from further access to the IVR 100. The blocking period can be indefinite or for a small, medium or large finite period (e.g., 1 hour, 2 hours, 24 hours) depending on the caller's historical misuse of the IVR 100. Call blocking can be accomplished by way of caller ID blocking or other conventional blocking means in existence or discovered in the future. The caller can also be notified in step 215 of the blocking status. This notification can include any information that the service provider deems appropriate. For example, the notification can state that the caller has been blocked from further access due to the frequency of calls and eradicate nature of his or her access. To not offend the caller who may be an important customer, the IVR 100 can communicate the blocking status to the caller with instructions on how to remedy the restriction. The instructions, for example, could direct the caller to a website where s/he can explain the nature of the erratic calls, and request removal of the block. Alternatively, the IVR 100 can instruct the caller to call a toll free number, which directs the caller to special service agents who can address chronic callers (such as in steps 220 and 222).

If, on the other hand, the caller is not blocked in step 212, the IVR 100 can in a first embodiment direct the caller to step 219 where a special services menu is presented to the caller, or in a second embodiment direct the caller to a human agent in steps 220 and 222. A special services menu 219 can be a number of call flow steps programmed in the IVR 100 in which the caller is queried as to nature of her behavior. Said queries can ask the caller whether s/he is having trouble with the call center, whether s/he is frustrated due to the waiting period, whether s/he is frustrated with the services being provided, whether s/he is confused with the call flows, and so on. Obviously, a number of inquiries can be invoked to establish a rationale for the caller's anomalous behavior. The caller can also be informed that s/he must be patient or will be subject to a caller block for a period of time. From step 219, the IVR 100 can either direct the caller to steps 220 and 222 for further processing by a service agent, or allow the caller continued use of the IVR 100 if the answers provided to the inquiries were reasonable (i.e., within acceptable parameters set by the service provider).

When directed to an agent, the IVR 100 presents the agent in step 220 the caller's frequency of call activity (e.g., involuntary terminations, voluntary terminations, time between calls, chronic status, etc.). The IVR 100 can also be programmed to retrieve and present account information of the caller in steps 216 and 218. The account information can inform the agent of the importance of the caller's business to the enterprise and whether the caller deserves special attention notwithstanding his or her aggressive and perhaps erratic behavior. With the information presented by steps 216 through 220, the agent in step 222 can make an informed decision mindful of policy established by the service provider on how best to address the caller's issues. In the decision process, the agent in step 222 can, for example, invoke steps 214 and 215 to block the caller from further access to the IVR 100 if the caller's cooperation is poor and rationale for his/her behavior is unreasonable. Alternatively, if the agent addresses the caller's needs satisfactorily, the agent can choose to do nothing to prevent the caller from future access to the IVR 100.

It should be also evident that the present disclosure may be used for many applications. Thus, although the description is made for particular arrangements and methods, the intent and concept of the disclosure is suitable and applicable to other arrangements and applications not described herein. It would be clear therefore to those skilled in the art that modifications to the disclosed embodiments described herein could be effected without departing from the spirit and scope of the claims described below.

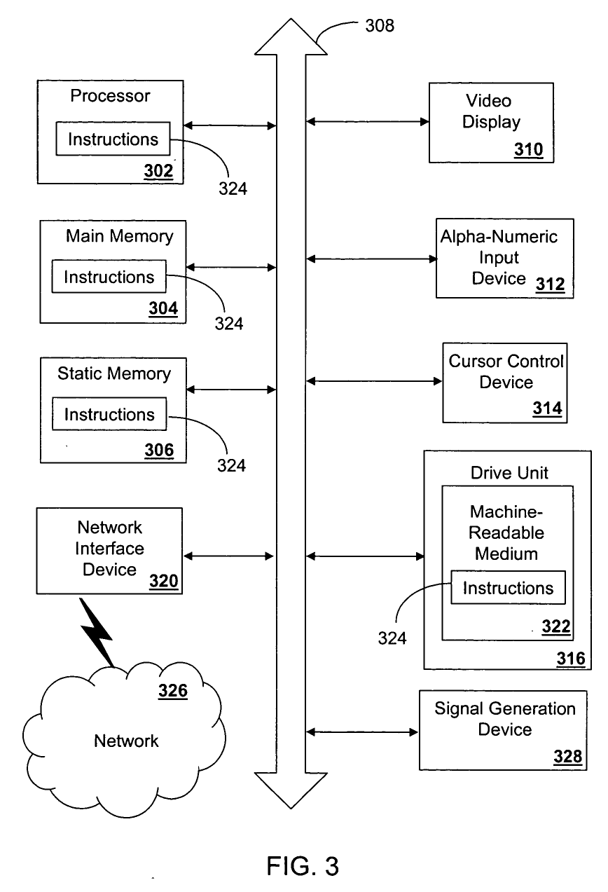

FIG. 3 is a diagrammatic representation of a machine in the form of a computer system 300 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment. The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 300 may include a processor 302 (e.g., a central processing unit (CPU), a graphics processing unit (GPU, or both), a main memory 304 and a static memory 306, which communicate with each other via a bus 308. The computer system 300 may further include a video display unit 310 (e.g., a liquid crystal display (LCD), a flat panel, a solid state display, or a cathode ray tube (CRT)). The computer system 300 may include an input device 312 (e.g., a keyboard), a cursor control device 314 (e.g., a mouse), a disk drive unit 316, a signal generation device 318 (e.g., a speaker or remote control) and a network interface device 320.

The disk drive unit 316 may include a machine-readable medium 322 on which is stored one or more sets of instructions (e.g., software 324) embodying any one or more of the methodologies or functions described herein, including those methods illustrated in herein above. The instructions 324 may also reside, completely or at least partially, within the main memory 304, the static memory 306, and/or within the processor 302 during execution thereof by the computer system 300. The main memory 304 and the processor 302 also may constitute machine-readable media. Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 324, or that which receives and executes instructions 324 from a propagated signal so that a device connected to a network environment 326 can send or receive voice, video or data, and to communicate over the network 326 using the instructions 324. The instructions 324 may further be transmitted or received over a network 326 via the network interface device 320.

While the machine-readable medium 322 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. For example, modifying step 208 so that it directs callers to either step 219 and/or steps 216 through 222 is an alteration to method 200 that is inclusive of the scope and spirit of the claims described below. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. An interactive voice response system (IVR), comprising:
a communications interface;
a memory; and
a controller programmed to:
monitor a frequency of call activity for each caller;
establish a redirection criterion; and
redirect a caller to special services when the frequency of call activity of said caller satisfies the redirection criterion.

2. The IVR of claim 1, wherein the frequency of call activity for each caller corresponds to at least one among a group of activities comprising a number of calls made by each caller, a number of voluntary call terminations by each caller, a number of involuntary call terminations by each caller, and a temporal reading for each call activity of a caller.

3. The IVR of claim 1, wherein special services corresponds to at least one among a special services menu, and a human agent.

4. The IVR of claim 3, wherein the controller is programmed to present to the human agent a portion of the frequency of call activity of the caller.

5. The IVR of claim 4, wherein the controller is programmed to:
retrieve account information corresponding to the caller; and
present to the human agent a portion of the account information.

6. The IVR of claim 1, wherein the redirection criterion corresponds to a threshold for identifying the caller as a chronic caller.

7. The IVR of claim 1, wherein the controller is programmed to:
establish an alert criterion; and
notify a service provider when the frequency of call activity of one or more callers satisfies the alert criterion.

8. The IVR of claim 1, wherein the controller is programmed to:
establish a filter criterion; and
block one or more callers when the frequency of call activity of said callers satisfies the filter criterion.

9. The IVR of claim 8, wherein the controller is programmed to notify the caller of the blocking status.

10. In an interactive voice response system (IVR) a computer-readable storage medium, comprising computer instructions for:
monitoring a frequency of call activity for each caller;
establishing a threshold for identifying chronic callers; and
redirecting a caller to special services when the frequency of call activity of said caller satisfies the threshold.

11. The storage medium of claim 10, wherein the frequency of call activity for each caller corresponds to at least one among a group of activities comprising a number of calls made by each caller, a number of voluntary call terminations by each caller, a number of involuntary call terminations by each caller, and a temporal reading for each call activity of a caller.

12. The storage medium of claim 10, wherein special services corresponds to at least one among a special services menu, and a human agent.

13. The storage medium of claim 12, comprising computer instructions for presenting to the human agent a portion of the frequency of call activity of the caller.

14. The storage medium of claim 13, comprising computer instructions for:
retrieving account information corresponding to the caller; and
presenting to the human agent a portion of the account information.

15. The storage medium of claim 10, comprising computer instructions for blocking callers who satisfy the threshold.

16. The storage medium of claim 10, comprising computer instructions for:
establishing an alert criterion; and
notifying a service provider when the frequency of call activity of one or more callers satisfies the alert criterion.

17. The storage medium of claim 10, comprising computer instructions for:
establishing a filter criterion; and
blocking one or more callers when the frequency of call activity of said callers satisfies the filter criterion.

18. In an interactive voice response system (IVR), a method comprising the steps of:
monitoring a frequency of call activity for each caller;
establishing a threshold for identifying chronic callers;
redirecting a caller to at least one among a special services menu, and a human agent when the frequency of call activity of said caller satisfies the threshold; and
blocking callers who satisfy the threshold.

19. The method of claim 18, wherein the frequency of call activity for each caller corresponds to at least one among a group of activities comprising a number of calls made by each caller, a number of voluntary call terminations by each caller, a number of involuntary call terminations by each caller, and a temporal reading for each call activity of a caller, wherein special services corresponds to a human agent, and wherein the method comprises the steps of:
retrieving account information corresponding to the caller; and
presenting to the human agent a portion of the frequency of call activity of the caller, and a portion of the account information corresponding to said caller.

20. The method of claim 18, comprising the steps of:
establishing an alert criterion; and
notifying a service provider when the frequency of call activity of one or more callers satisfies the alert criterion.
